(19) United States
(12) Patent Application Publication
(10) Pub. No.: US 2005/0146161 A1
(43) Pub. Date: Jul. 7, 2005

(54) Under-vehicle aerodynamic efficiency improvement device

(76) Inventor: William Burley Uland, Hopkinsville, KY (US)

Correspondence Address: William Burley Uland, 3120 Kountry Spring Lane, Hopkinsville, KY, 42240, US

(21) Appl. No.: 10/984,229

(22) Filed: Nov. 9, 2004

Related U.S. Application Data
(60) Provisional application No. 60/534,822, filed on Jan. 5, 2004.

(51) Int. Cl. B62D 35/02

(52) U.S. Cl. 296/180.1

(57) ABSTRACT

This invention relates to a device used to cover the chassis of a vehicle, mounted forward of the rear axle assembly(ies) to smooth and enhance the flow of air from under and around the area forward and to the sides of the rear axle assembly(ies). This invention also acts as a protective barrier for the chassis of the vehicle utilizing this device.

### BACKGROUND OF INVENTION/TECH FIELD

The present invention relates to a device and the component parts used to cover portions or sections of a vehicle, motorized, or pulled in combination, to improve aerodynamic efficiency.

Most vehicles manufactured today are designed to improve aerodynamic efficiency by the shaping of external vehicle surfaces to reduce aerodynamic drag, thereby reducing fuel consumption. Manufacturers of vehicles use computers, full scale models, and scaled down models to determine optimum airflow over and around the vehicle and its external components.

This invention addresses the problem of airflow under a vehicle with an exposed undercarriage and axle assembly, such as a truck-trailer combination vehicle, a box van, or an extended wheelbase truck. The airflow problems encountered by these vehicles open undercarriage increase fuel consumption by causing an increase in aerodynamic drag.

### BRIEF SUMMARY

This invention is intended to be a cover over the undercarriage of trucks, vans, and truck-trailer combination vehicles. This device is aerodynamically designed to correct airflow patterns under a vehicle prone to develop or create turbulent airflow patterns which increases aerodynamic drag on the vehicle which results in increased fuel consumption. Covering the problem areas and diverting the airflow from under the vehicle will allow for increased vehicle efficiency and add a protective cover for the exposed areas under a vehicle. In the effort to increase fuel efficiency in all vehicles, aerodynamic improvements have been an ongoing process. This invention is intended to continue that process.

### DESCRIPTION OF DRAWING

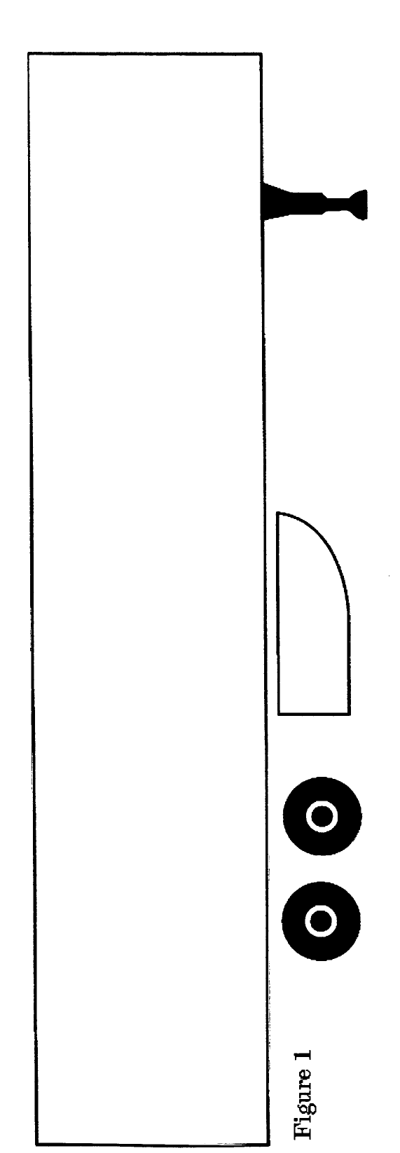

As seen in FIG. 1, the invention is mounted to the undercarriage of a vehicle ahead of the rear wheel and axle assemblies to form a cover over the undercarriage and to promote airflow efficiency under said vehicle. The shape of the device will match each individual make and model and will be shaped aerodynamically to gain the most improvement in airflow efficiency.

### DESCRIPTION OF INVENTION

The device is positioned under a vehicle that has open space ahead of the rear axle assembly. The device is designed to improve the flow of air from the bottom and sides of the vehicle.

The device can be made of several different materials including, but not limited to: ABS plastic, polystyrene, polyethylene, cross-linked polyethylene, resin-filled glass, glass fiber matting, chopped fiber matting, carbon fiber matting, and other materials of a like nature used in similar manufacturing processes. The use of these types of materials will allow for simple manufacturing of the device. The type of material used will be based on the shape, size, and cost of manufacturing, as well as structural strength needed, impact absorption and deflection ability, ultraviolet light resistance, and anticipated length of time the device can remain in service in a particular application. The manufacturing of this device may consist of one of the following present known techniques or a technique not yet discovered:
1.) A single or multi-piece mold where a liquid flowable substance is injected or poured into the mold and cured in a normal fashion consistent with the requirements of the substance being used. Coloring will be accomplished with dye added during process or a coating applied after curing.
2.) A single or multi-piece mold where a dry-flowable, palletized, or granulated substance is injected, or poured into the mold and heated to form a liquid or semi-liquid state inside the mold to conform to the shape of the mold. Curing of the material will be consistent with the requirements of the substance being used. Coloring will be accomplished with dye added during process or a coating applied after curing.
3.) A form or shaped buck where a sheet of fabric, carbon fiber, or fiberglass woven cloth is laid over or inside the shaped form or buck and a resin epoxy is applied to the material and saturated sufficiently in accordance with the requirements of the material being used. Curing of the material will be consistent with the requirements of the substance being used. Coloring will be accomplished with dye added during process or a coating applied after curing.
4.) A mold where chopped fiberglass or similar material is sprayed onto the surface of the mold to create the shape of the device. A gel coat top surface may be applied first to the mold to create coloring or proper texture of outer surface. During application of material, an epoxy resin mix will be added to saturate sufficiently to create uniform thickness and strength. Curing of material will be consistent with the requirements of the substance being used. Coloring will be accomplished with dye added during process or a coating applied after curing.

All construction methods may also incorporate reinforcing devices placed inside, on top of, or behind the substance being used to construct the device. The reinforcement may be in the form of metal round stock, metal flat stock, metal angle stock, plastic or polymer strips, or thickness variations in stress areas. Reinforcing may be accomplished in the form of extra strengthening ribs molded into or added to the device while in the form(s).

The reinforcement of the device will add to the longevity of the device by avoiding breakage or lack of usefulness due to fatigue or damage to said device. The mounting of the device will be based on the requirements of each individual make and model of chassis the device will be attached to.

Individual requirements of mounting may include one or more of the following methods: nuts and bolts, quick release fasteners, quick release latches, quick release pins, quarter turn fasteners, rivets, or any other permanent or semi-permanent attaching methods.

The shape of the form is to be one that promotes a reduction of aerodynamic drag and turbulence under the chassis of the vehicle utilizing the device. The device will have subtle or significant variation among the different makes and models of chassis based on the constraints of and size limitations of each make and model of chassis utilizing the device. By smoothing the airflow under the chassis and reducing aerodynamic drag and turbulence, vehicle efficiency is increased thereby reducing fuel consumption of the vehicle the device is installed upon.

The shape of the device will be determined by one or more of the following ways: construction and testing on scaled down models, construction and testing on full size models, computer simulations, environmental needs, chassis restrictions, size considerations, ground clearance concerns, obstruction concerns, Federal Motor Vehicle requirements and/or limitations, real world testing, wind tunnel testing.

The device will be designed to be semi-permanently attached to the chassis of the vehicle. This will allow for any necessary repairs to be made to the chassis by removing the device when necessary. This will also allow for repairs to be made to the device itself should repairs become necessary. The semi-permanent attaching of the device will also allow for any maintenance that is required to be performed on the chassis when needed. The device may also incorporate or contain access panels to allow for inspections or minor repairs of components cover and protected by the device.

The device will mount to the chassis of the vehicle and extend downward toward the ground but will not touch the ground.

1.) A device for a motorized or pulled vehicle (i.e., trailer), that forms a cover for the undercarriage of said vehicle.

2.) Said device designed to:
A.) Cover chassis of said vehicle to form a protective barrier from weather and debris;
B.) Improve airflow under vehicle, thereby improving fuel efficiency of the vehicle.
